(19) United States
(12) Patent Application Publication
(10) Pub. No.: US 2011/0191807 A1
(43) Pub. Date: Aug. 4, 2011

(54) ELECTRONIC DEVICE AND DATA RECEIVING METHOD

(76) Inventor: Hiroki Kumagai, Tokyo (JP)

(21) Appl. No.: 12/892,763

(22) Filed: Sep. 28, 2010

(30) Foreign Application Priority Data
Jan. 29, 2010 (JP) 2010-019704

(51) Int. Cl. H04N 5/445

(52) U.S. Cl. 725/51

(57) ABSTRACT

In one embodiment, there is provided an electronic device. The device includes: a program-related information receiver configured to receive program-related information provided by broadcast waves; a page data receiver configured to receive data of a Web page at a given time based on text data included in the program-related information; and a storage configured to store the data of the Web page in a storage medium.

### CROSS-REFERENCE TO RELATED APPLICATION

This application claims priority from Japanese Patent Application No. 2010-019704, filed on Jan. 29, 2010, the entire contents of which are hereby incorporated by reference.

### BACKGROUND

1. Field

Embodiments described herein generally relate to an electronic device and a data receiving method.

2. Description of the Related Art

With the advance of recent technology development, a broadcast receiver having a function not only capable of acquiring program-related information of broadcast programs provided by broadcast waves but also capable of making connection to the Internet has been provided as a broadcast wave receiver such as a DTV (Digital Television).

When this function is used, a Web page loaded with information about broadcast programs on the Internet can be referred to, so that information about broadcast programs to be viewed or having been viewed can be browsed on the broadcast receiver.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic view showing a DTV in an embodiment of the invention and an example of an available environment of the DTV;

FIG. 2 is a block diagram showing an example of internal configuration of the DTV in the embodiment of the invention;

FIG. 3 is a block diagram showing an example of functional configuration about part of functions of the DTV in the embodiment of the invention;

FIG. 4 is a conceptual view showing an example of internet search contents in the embodiment of the invention;

FIG. 5 is a view showing an example of a display on which an EPG image is displayed in the embodiment of the invention;

FIG. 6 is a view showing an example of the display on which a network search scheduling screen is displayed in the embodiment of the invention;

FIG. 7 is a view showing an example of the display on which a contents selection screen is displayed in the embodiment of the invention;

FIG. 8 is a view showing an example of the display on which a searched Web page is displayed in the embodiment of the invention;

FIG. 9 is a flow chart showing an example of processing concerned with Web page search scheduling in the embodiment of the invention;

FIG. 10 is a flow chart showing an example of a selected program search process in the embodiment of the invention; and

FIG. 11 is a flow chart showing an example of a searched Web page display process in the embodiment of the invention.

### DETAILED DESCRIPTION

According to exemplary embodiments of the present invention, there is provided an electronic device. The device includes: a program-related information receiver configured to receive program-related information provided by broadcast waves; a page data receiver configured to receive data of a Web page at a given time based on text data included in the program-related information; and a storage configured to store the data of the Web page in a storage medium.

An embodiment of the invention will be described below with reference to the drawings.

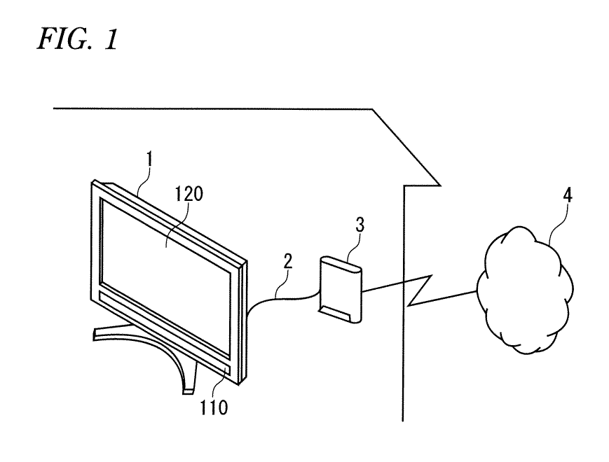

FIG. 1 is a schematic view showing a DTV 1 in the embodiment and an example of an available environment of the DTV 1.

The DTV 1 is a digital television as an example of an electronic device in the embodiment. The DTV 1 has a function of extracting audio video information from a broadcast signal of received broadcast waves and outputting the audio video information from a display 120 and a speaker 110. In addition, the DTV 1 is connected communicably to a router 3 through an LAN (Local Area Network) cable 2 based on an LAN specification which is a communication specification for enabling exchange of signals between connected devices. The router 3 is a communication device having a routing function for setting a transfer route of communication data. For example, the router 3 is connected to the Internet 4 which is a wide area network (WAN).

In addition, the DTV 1 can acquire a predetermined uploaded Web page (a Web page stored in a predetermined server) from the Internet 4 through the router 3. Although the DTV 1 is shown here as an example of the electronic device according to the invention, the present embodiment is not limited thereto. Various devices such as various recorders such as an STB (Set Top Box), an HDD (Hard Disk Drive) recorder and a DVD (Digital Versatile Disc) recorder can be conceived as other examples of the electronic device.

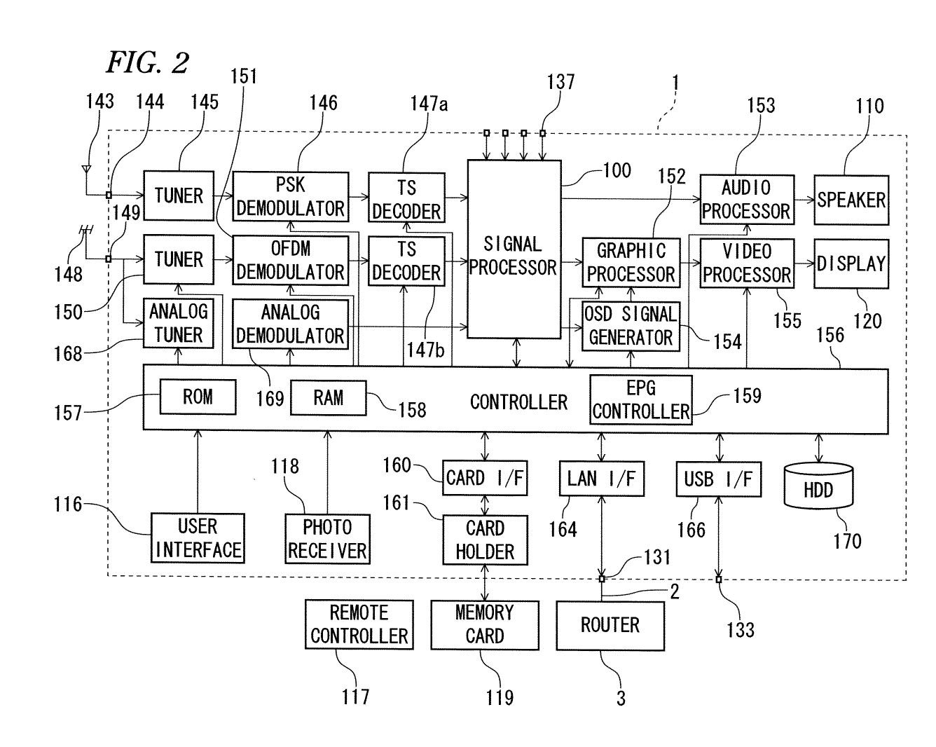

FIG. 2 is a block diagram showing an example of internal configuration of the DTV 1 in the embodiment.

The DTV 1 has a controller 156 for controlling operations of respective portions of the device. The controller 156 has a built-in CPU (Central Processing Unit), etc. The controller 156 activates a system control program and various processing programs stored in advance in an ROM (Read Only Memory) 157 in accordance with an operation signal inputted from a user interface 116 and an operation signal transmitted from a remote controller 117 and received through a photo receiver 118. The controller 156 controls operations of the respective portions of the device in accordance with the activated programs while using an RAM (Random Access

Memory) 158 as a work memory.

An input terminal 144 is provided so that a satellite digital television broadcast signal received by a BS/CS digital broadcast receiving antenna 143 is provided to a satellite digital broadcast tuner 145. The tuner 145 tunes the received digital broadcast signal and transmits the tuned digital broadcast signal to a PSK (Phase Shift Keying) demodulator 146. The PSK demodulator 146 demodulates a TS (Transport Stream) and provides the demodulated TS to a TS decoder 147a. The TS decoder 147a decodes the TS into a digital signal including a digital video signal, a digital audio signal and a data signal and then outputs the decoded digital signal to a signal processor 100. The digital video signal mentioned herein is a digital signal concerned with video which can be outputted by the DTV 1. The audio signal is a digital signal concerned with audio which can be outputted by the DTV 1. In addition, the data signal is a digital signal concerned with information about broadcast programs of broadcast waves, including program-related information which is information used when, for example, the DTV 1 creates an EPG (Electronic Program Guide) as an electronic program table. The program-related information includes information such as the title of each broadcast program, detailed information of the program, program start time, program end time, etc.

An input terminal 149 is provided so that digital terrestrial television broadcast signals received by a digital terrestrial broadcast receiving antenna 148 are provided to digital terrestrial broadcast tuners 150 respectively. The tuners 150 tune the received digital broadcast signals and transmit the tuned digital broadcast signals to OFDM (Orthogonal Frequency Division Multiplexing) demodulators 151 respectively. The OFDM demodulators 151 demodulate TS's and provide the demodulated TS's to TS decoders 147b respectively. Each TS decoder 147b decodes the TS into digital video and audio signals etc. and then outputs the decoded video and audio signals etc. to the signal processor 100. Digital terrestrial television broadcasts acquired by eleven tuners 150 respectively can be decoded simultaneously as digital signals each containing a digital video signal, a digital audio signal and a data signal by the OFDM demodulators 151 and the TS decoders 147b, and then outputted to the signal processor 100.

The antenna 148 can also receive an analog terrestrial broadcast signal. The received analog terrestrial broadcast signal is allotted by an allotter not shown, and provided to an analog tuner 168. The analog tuner 168 tunes the received analog broadcast signal and transmits the tuned analog broadcast signal to an analog demodulator 169. The analog demodulator 169 demodulates the analog broadcast signal and outputs the demodulated analog broadcast signal to the signal processor 100. In addition, to take an example, CATV (Common Antenna Television) can be viewed on the DTV 1 when a CATV tuner is connected to the input terminal 149 to which the antenna 148 is connected.

The signal processor 100 applies suitable signal processing to the digital signal outputted from the TS decoder 147a or 147b or the controller 156. More specifically, the signal processor 100 separates the digital signal into a video signal, a digital audio signal and a data signal. The separated video signal is outputted to a graphic processor 152 whereas the separated audio signal is outputted to an audio processor 153. In addition, the signal processor 100 converts the broadcast signal outputted from the analog demodulator 169 into a video signal and an audio signal with a predetermined digital format. The converted digital video signal is outputted to the graphic processor 152 whereas the converted digital audio signal is outputted to the audio processor 153. In addition, the signal processor 100 applies predetermined digital signal processing also to input signals from line input terminals 137. The signal processor 100 further transmits the data signal to the controller 156. Accordingly, the controller 156 can store program-related information obtained from the received data signal into an HDD 170, so that the program-related information can be used for generating EPG later.

An OSD (On Screen Display) signal generator 154 generates an OSD signal for displaying a UI (User Interface) screen, etc. under the control of the controller 156. In addition, the data signal separated from the digital broadcast signal in the signal processor 100 is converted into an OSD signal with a suitable format by the OSD signal generator 154, and then outputted to the graphic processor 152.

The graphic processor 152 decodes the digital video signal outputted from the signal processor 100. The decoded video single is superposedly combined with the OSD signal outputted from the OSD signal generator 154, and then the resulting video signal is outputted to a video processor 155. The graphic processor 152 can also selectively output the decoded video signal or OSD signal to the video processor 155.

The video processor 155 converts the signal outputted from the graphic processor 152 into an analog video signal with a format displayable on the display 120. The thus converted digital video signal is displayed on the display 120.

The audio processor 153 converts the inputted audio signal into an analog audio single with a format reproducible by the speaker 110. The thus converted analog audio signal is outputted to the speaker 110 and reproduced by the speaker 110.

A card holder 161 is connected to the controller 156 through a card I/F (Interface) 160. A memory card 119 can be mounted into the card I/F 160. The memory card 119 is a storage medium such as an SD (Secure Digital) memory card, an MMC (Multimedia Card) or a CF (Compact Flash) card. The controller 156 can write/read information into/from the memory card 119 mounted in the card holder 161, through the card I/F 160. An LAN terminal 131 is connected to the controller 156 through an LAN I/F 164. The LAN terminal 131 is used as a general LAN support port using Ethernet (registered trademark). In this embodiment, the LAN cable 2 is connected to the LAN terminal 131 so that the controller 156 can communicate with the router 3.

A USB (Universal Serial Bus) terminal 133 is connected to the controller 156 through a USB I/F 166. The USB terminal 133 is used as a general USB support port. A cellular phone, a digital camera, a card reader/writer supporting various memory cards, an HDD, a keyboard, etc. are connected to the USB terminal 133, for example, through a hub. The controller 156 can perform communication (transmission/reception) of information with devices connected through the USB terminal 133.

The HDD 170 is a magnetic storage medium built in the DTV 1. The HDD 170 has a function of storing various kinds of information of the DTV 1. The controller 156 stores program-related information obtained from a data signal received from the signal processor 100 into the HDD 170. The program-related information is information which is concerned with broadcast programs provided by broadcast stations and which is used when the DTV 1 creates an EPG. An EPG controller 159 of the controller 156 can generate an EPG using the program-related information. In addition, the HDD 170 stores moving picture contents which are moving picture data displayable on the DTV 1. The controller 156 can play back the moving picture contents.

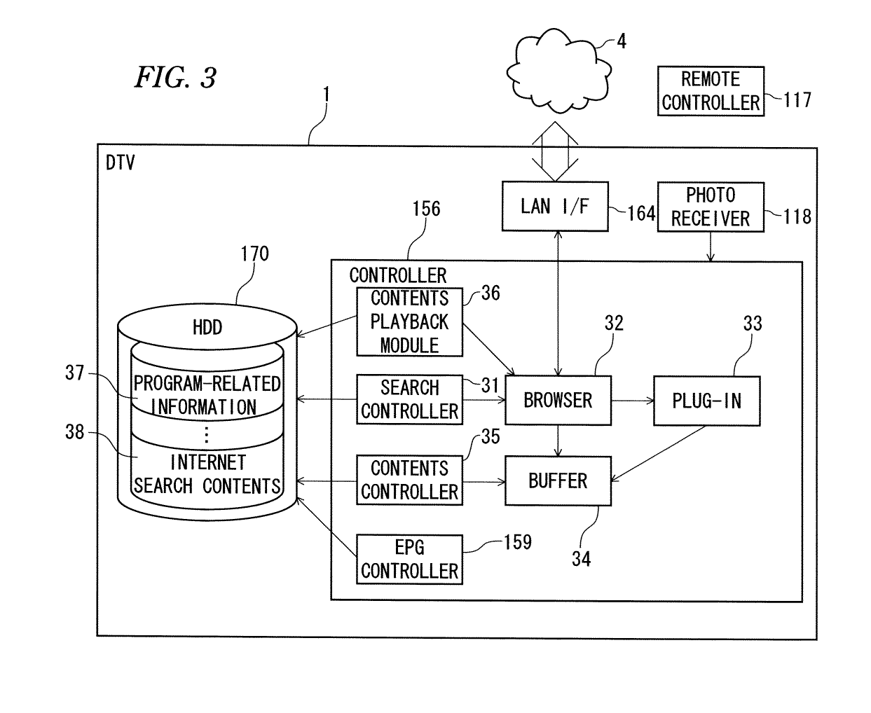

The functional configuration of functions about processing executed by the DTV 1 in the embodiment will be described below with reference to FIG. 3.

FIG. 3 is a block diagram showing an example of functional configuration about part of functions of the DTV 1 in the embodiment.

The DTV 1 in the embodiment searches a Web page loaded with information about a broadcast program at a time desired by the user by using a search site which is a search Web page on the Internet 4. The DTV 1 stores information of the hit Web page as internet search contents in the HDD 170. At the time of search, for example, the DTV 1 searches a Web page from the retrial site while text data of program title information contained in information stored as program-related information 37 in the HDD 170 is used as a keyword. In addition, the Web page stored as internet search contents in the HDD 170 can be displayed on the display 120. FIG. 3 shows a search controller 31, a browser 32, a plug-in 33, a buffer 34, a contents controller 35 and a contents playback module 36 as a module concerned with functions for executing part of these processes.

The search controller 31 has a function of searching a Web page associated with a broadcast program. The search controller 31 starts up the browser 32, searches a Web page from a search site acquired by the browser 32 while using a program title as a keyword, and expands the searched Web page on the browser 32. Information of the program title used as the keyword on this occasion is extracted and acquired from the program-related information 37. In addition, the search controller 31 has a function of transmitting the information of the program title used for the search on this occasion to the contents controller 35.

The browser 32 has a function of accessing the Internet 4 to acquire a Web page on the Internet 4 and creating a signal for displaying the Web page on the display 120. In addition, when there are moving pictures, etc. which cannot be displayed by the browser 32 alone but can be played back by the plug-in 33, the browser 32 has a function of starting up the plug-in 33 to play back the moving pictures. In addition, when a display image of a Web page is created, the browser 32 stores an image of the Web page, a configuration file necessary for creation of the image of the Web page, and an execution status (including process resources necessary for restoration) which is a self-operation image for creation of the display image of the Web page, in the buffer 34.

The plug-in 33 has a function of acquiring self-reproducible moving picture data from a Web page in accordance with an instruction given from the browser 32, and playing back moving pictures by using the moving picture data. In addition, the plug-in 33 stores the acquired moving picture data in the buffer 34.

The buffer 34 has a function of storing the image, the configuration file and the execution status used when the browser 32 creates the display image of the Web page, and the moving picture data acquired by the plug-in 33. The image, the configuration file and the execution status used when the browser 32 creates the display image of the Web page will be hereinafter referred to as Web page display-related information generically.

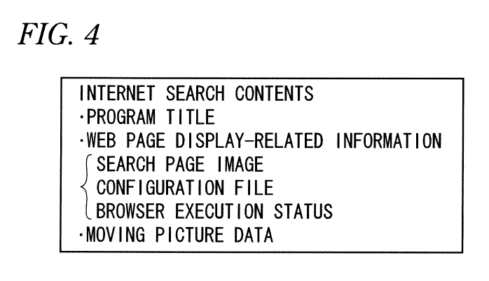

The contents controller 35 has a function of storing as internet search contents in the HDD 170 the Web page display-related information of the browser 32 and the moving picture data stored in the buffer 34 and the program title used as the keyword received from the search controller 31 for searching the Web page while associating the Web page display-related information and the moving picture data with the program title. FIG. 4 is a conceptual view showing an example of the internet search contents in the embodiment.

The contents playback module 36 has a function of expanding the Web page of the internet search contents stored in the HDD 170. The contents playback module 36 creates a contents selection screen which is a selection screen for making the user select internet search contents to be played back, and makes the browser 32 display a Web page having relevant information stored therein as internet search contents 38, based on a user's input on the selection screen. On this occasion, the contents playback module 36 transmits Web page display-related information and moving picture data in the internet search contents to the browser 32. The browser 32 expands the Web page based on these received data and transmits audio and video signals to the video processor 155 and the audio processor 153 to thereby output an image and sound of the Web page.

As described above, moving picture contents are stored in the HDD 170. The contents playback module 36 has a function of playing back the moving picture contents. The contents playback module 36 can display moving picture contents selectively on the contents selection screen like the internet search contents so that moving picture contents selected by the user can be played back. The contents selection screen will be described later.

The EPG controller 159 has a function of creating an EPG image by using the program-related information stored in the HDD 170. An image signal generated by the EPG controller 159 is transmitted to the OSD signal generator 154 so that the DTV 1 can display an EPG on the display 120.

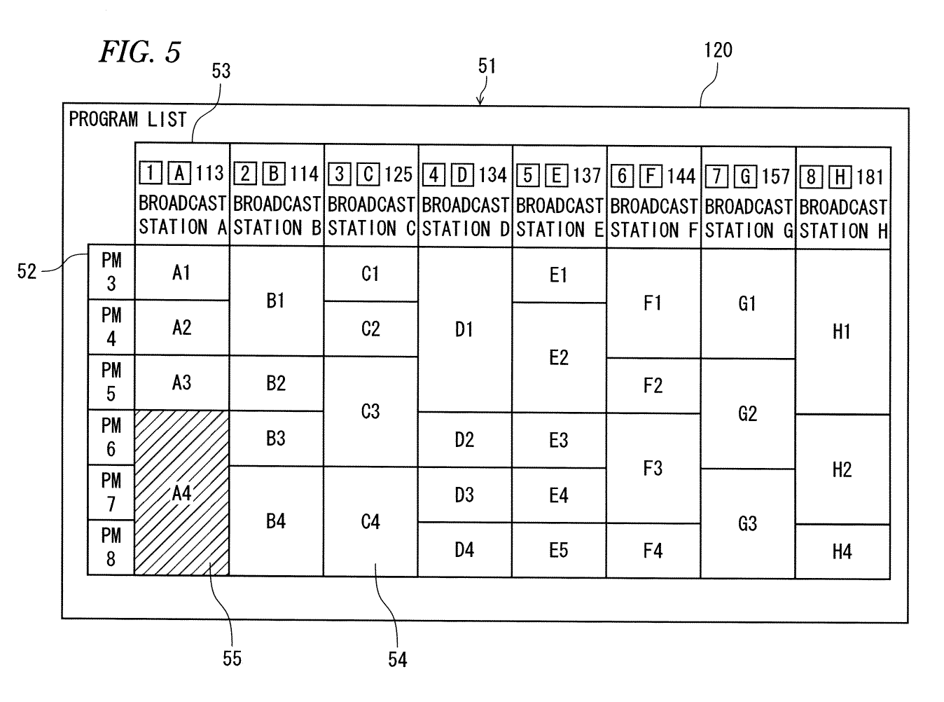

Here, an EPG image created by the EPG controller 159 and displayed on the display 120 will be described below with reference to FIG. 5.

FIG. 5 is a view showing an example of the display 120 on which an EPG image is displayed in the embodiment. The display 120, an EPG 51, a broadcast time display field 52, a station information display field 53, a program field 54 and a selection cursor 55 are shown in FIG. 5.

The EPG 51 is an electronic program table in which respective broadcast stations are arranged horizontally and displayed on a display screen 121 while programs broadcasted in respective time zones are arranged downwards vertically along the passage of time and displayed on the display screen 121.

The broadcast time display field 52 indicates the broadcast time of each program.

The station information display field 53 is a display field for displaying information of each broadcast station.

The program field 54 is a field in which information of a program broadcasted at a time displayed on a left side by each broadcast station displayed in the station information display field 53 located on an upper side is written. The information shown here is information superposed on a data signal acquired from broadcast waves. Although the embodiment has been described in the case where broadcast program information such as a data signal is acquired from broadcast waves by way of example, the present embodiment is not limited thereto. For example, the broadcast program information may be acquired from the Internet 4, etc. through an LAN I/F, etc.

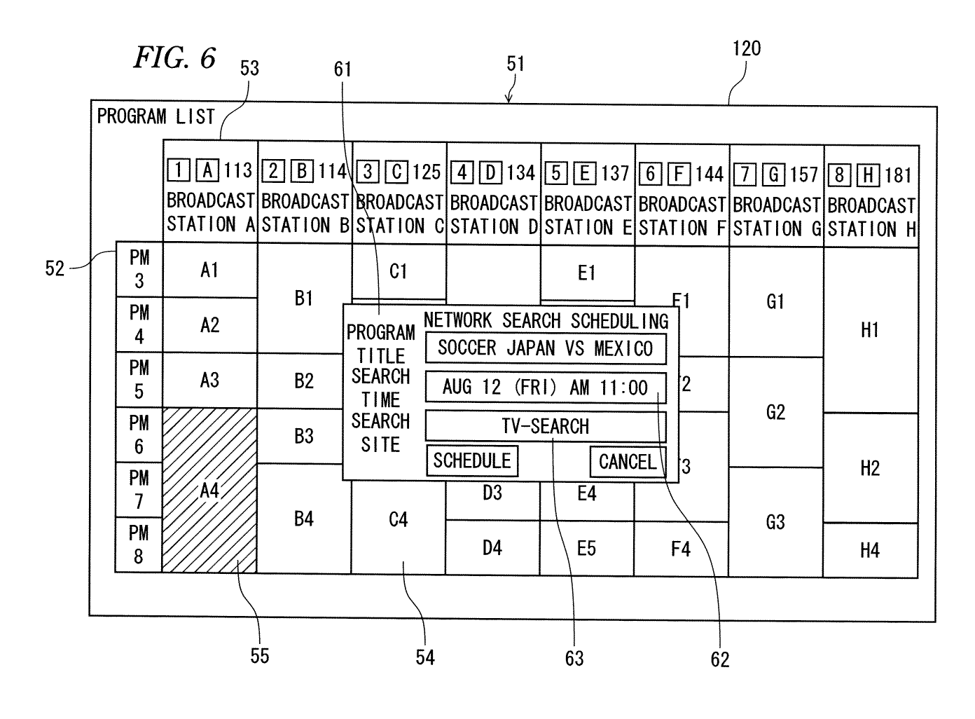

The selection cursor 55 is a cursor for selecting a program or a broadcast station, etc. The user can operate the selection cursor 55 to select one from the programs displayed on the EPG 51 so that the user can perform various operation inputs such as viewing, recording, or audio output of the selected program, etc. In addition, the user can use the selection cursor 55 to select a program for searching the Web page. When the program is selected by the selection cursor 55, the EPG controller 159 displays a network search scheduling screen which is a selection screen for selecting a search site and a search time for searching the selected program, and further makes the user select the search site and the search time for performing search. The network search scheduling screen will be described below with reference to FIG. 6.

FIG. 6 is a view showing an example of the display 120 on which a network search scheduling screen is displayed in the embodiment. In FIG. 6, a network search scheduling screen 61 is displayed on the EPG 51 shown in FIG. 5.

Information for selecting a program title, a search time, a search site and whether to schedule the searched program or not is displayed on the network search scheduling screen 61. The user can select a search time and a search site from a search time box 62 and a search site box 63. The search controller 31 performs search with a program title as a keyword on the search site designated on the search site box 63 at the time designated on the search time box 62 based on a result of the selection. That is, the EPG controller 159 serves as a notification output module for notifying the user of information about the search time. In addition, the network search scheduling screen 61 serves as a setting screen for making the user set a search time.

The network search scheduling screen 61 serves as a notification unit for notifying the user of a search time.

In the embodiment, the DTV 1 searches a Web page relevant to a broadcast program based on the selected search site. Because the DTV 1 makes the user select a broadcast program while displaying the EPG 51 to the user, the user can select a program while viewing lots of information so that it is easy for the user to understand. In addition, the user can confirm a broadcast time of a target program easily.

Although this embodiment has been described in the case where the user can select an arbitrary time as the search time, a time which can be acquired from program-related information may be displayed as a default value in the search time box 62. For example, a broadcast start time, a broadcast end time, etc. of a program may be used as the default value. In addition, a time may be selectively displayed in the search time box 62 in such a form of “N hours after the program broadcast end time”. In this manner, search can be performed at the time relevant to the broadcast program.

The DTV 1 can search information about a Web page, store the acquired information as internet search contents in the HDD 170 and display the internet search contents later. On this occasion, the contents playback module 36 creates a contents selection screen which is a screen for selecting internet search contents to be displayed. Next, an example of the contents selection screen will be described.

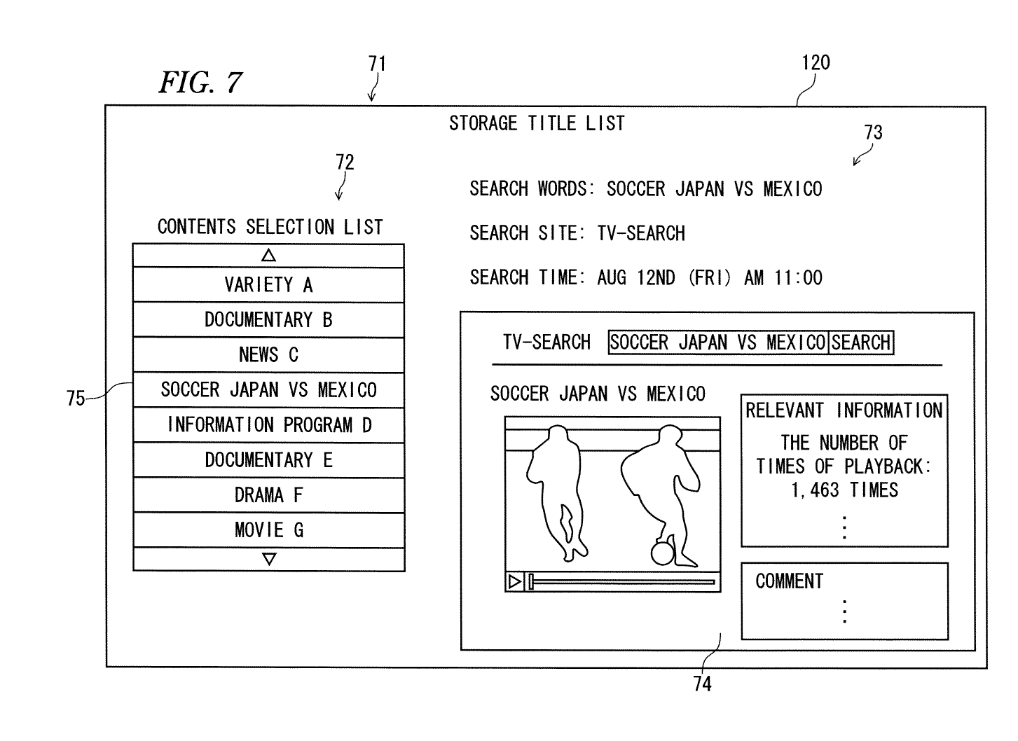

FIG. 7 is a view showing an example of the display 120 on which a contents selection screen 71 is displayed in the embodiment. The display 120, the contents selection screen 71, a contents selection list 72, contents information 73, a contents display screen 74 and a cursor 75 are shown in FIG. 7.

The contents selection list 72, the contents information 73, the contents display screen 74 and the cursor 75 are displayed on the contents selection screen 71 displayed on the display 120. Although these components are exemplified as information displayed on the contents selection screen 71, the contents of the information and the display form of the information are not limited thereto.

Internet search contents and titles of moving picture contents stored in the HDD 170 are displayed on the contents selection list 72. The user can select one from these contents by moving the cursor 75 vertically. Here, the internet search contents and the titles of the moving picture contents stored in the HDD 170 are displayed in the contents selection list 72 so as to be arranged in the same display form.

Information associated with the internet search contents/the moving picture contents selected by the cursor 75 from the contents selection list 72 is displayed in the contents information 73. The display screen of the internet search contents/the moving picture contents selected by the cursor 75 is displayed on the contents display screen 74. Display of the contents display screen 74 may include moving pictures or a still image.

In the embodiment, moving picture contents and internet search contents stored in the HDD 170 are displayed in the same form as represented by the contents selection list 72 so as to make the user select one from the moving picture contents and the internet search contents. Accordingly, the user can view the internet search contents with the same feeling as when the user views the moving picture contents, so that the user can view the moving picture contents and the internet search contents as if both the moving picture contents and the internet search contents were contents of the same type.

The contents selected from the contents selection list 72 are displayed on the display 120. Accordingly, when the internet search contents are selected, the user can view a Web page of the selected internet search contents. A display screen with the Web page displayed thereon will be described below.

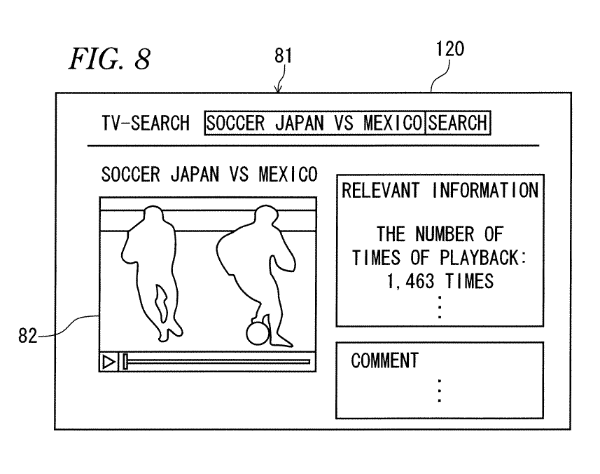

FIG. 8 is a view showing an example of the display 120 on which a searched Web page is displayed in the embodiment.

The contents controller 35 performs control so that Web page display-related information of the browser 32 about a Web page 81 searched on a search site designated by the user at a time designated by the user is stored together with moving picture data played back by the plug-in 33 and a program title as internet search contents in the HDD 170. When the user instructs the DTV1 to view the internet search contents, the search controller 31 reads the internet search contents from the HDD 170, displays the internet search contents by the browser 32 and plays back the internet search contents by the plug-in 33. The Web page 81 displayed on the display 120 on this occasion is shown in FIG. 8.

The Web page 81 concerned with the broadcast program searched by the search controller 31 is displayed on the display 120. The Web page 81 includes moving pictures 82 which are moving pictures able to be played back by the plug-in 33. Other regions than the moving pictures 82 are expanded and drawn by the browser 32 whereas the moving pictures 82 are expanded and played back by the plug-in 33.

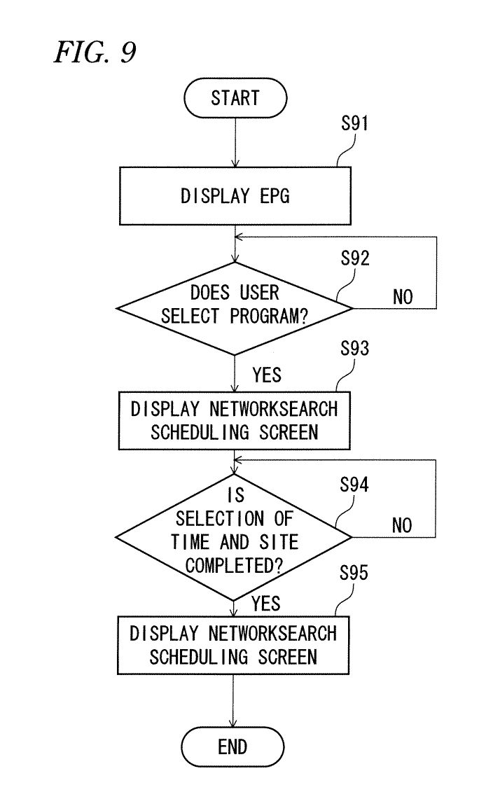

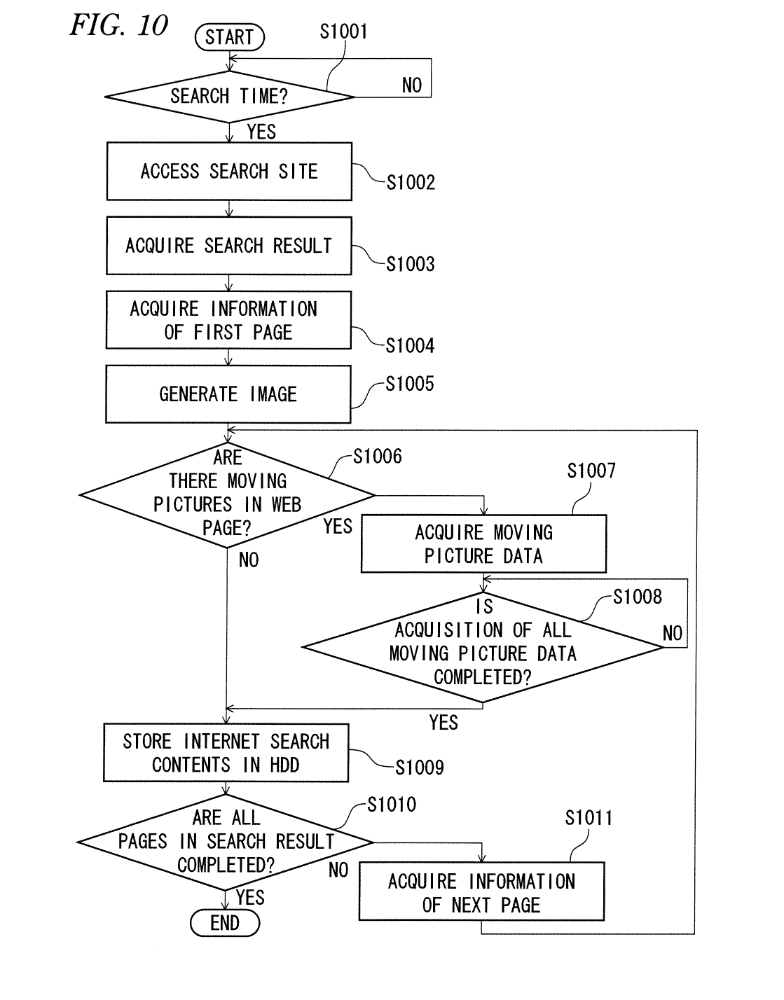

Next, processing executed by the DTV 1 in the embodiment will be described below with reference to FIGS. 9 and 10.

FIG. 9 is a flow chart showing an example of a process concerned with search scheduling of a Web page in the embodiment.

First, the EPG controller 159 of the DTV 1 displays the EPG screen 51 (step S91). Then, when a user selects a relevant Web page on a search page by using the selection cursor 55 (Yes in step S92), the EPG controller 159 displays a network search scheduling screen 61 (step S93).

When the user does not make any selection in the step S92 (No in the step S92), the processing flow goes back to the step S92 again. After the EPG controller 159 displays the network search scheduling screen 61 in the step S93, the DTV 1 waits for user's selection of a search time and a search site, for example, by using the remote controller 117 etc. (step S94).

While no selection is entered in the step S94 (No in the step S94), the DTV 1 waits continuously. When selection is entered, the search controller 31 extracts the program title of the selected program and stores the program title of the selected program together with the selected search time and search site in a cache (not shown) of the DTV 1. Here, these pieces of information may be stored in the HDD 170 instead.

Consequently, the sequence of the processing flow about search scheduling of the Web page is terminated.

FIG. 10 is a flow chart showing an example of a selected program search process in the embodiment.

The search controller 31 has a timer which is not shown but can detect the current time. The search controller 31 compares the current time with a search time stored in a cache of the search controller 31 and determines whether the current time has come to the search time or not (step S1001).

If the current time has not come to the search time in the step S 1001 (No in the step S1001), the search controller 31 waits. When the current time has come to the search time in the step S1001, the search controller 31 controls the browser 32 to access a search site selected from the search site box 63 of the network search scheduling screen 61 by the user (step S1002).

The search controller 31 searches Web pages relevant to the program with the program title as a keyword by using the search site and acquires a result of the search (step S1003).

After acquisition of the search result, the search controller 31 acquires data of a first one of the Web pages shown as the search result from the Internet 4 (step S1004).

The browser 32 creates an image of the Web page based on the acquired data of the Web page (step S1005). Here, the browser 32 stores the created image in the buffer 34. The browser 32 further stores a configuration file for expansion of the Web Pages and an execution status of the browser 32 in the buffer 34.

When the acquired Web page includes moving pictures which can be played back by the plug-in 33 (Yes in step S1006), the browser 32 starts up the plug-in 33 and the plug-in 33 acquires moving picture data from the Internet 4 (step S1007) and stores the moving picture data successively in the buffer 34. The plug-in 33 continues acquisition of the moving picture data unless all the moving picture data are acquired (No in step S1008).

When acquisition of all the moving picture data is completed (Yes in the step S1008), the contents controller 35 performs control so that the image of the Web page, the configuration file, the execution status of the browser 32 and the moving picture data stored in the buffer 34 are stored together with the program title used for search of the Web page as internet search contents in the HDD 170 (step S1009).

When there are no moving picture data in the step S1006 (No in the step S1006), internet search contents (the program title and the Web page display-related information) not including any moving picture data are stored in the HDD (the step S1009).

When the internet search contents stored in the step S1009 are not related to the last one of the Web pages obtained as the search result (No in step S1010), the search controller 31 acquires data of Web pages obtained as the next search result from the Internet 4 (step S1011). When processing in the step S1011 is completed, the processing flow returns to the step S1006.

When the contents stored in the step S1009 are related to the last one of the searched Web pages (Yes in the step S1010), the DTV 1 terminates the sequence of the processing flow about search scheduling of Web pages.

Although description has been made in the case where all Web pages searched in this processing flow are acquired, the present embodiment is not limited thereto. For example, only a first one of the listed Web pages may be acquired while the other Web pages are not acquired. On this occasion, data to be stored in the HDD 170 can be reduced while the Web page as the search result about the broadcast program is acquired.

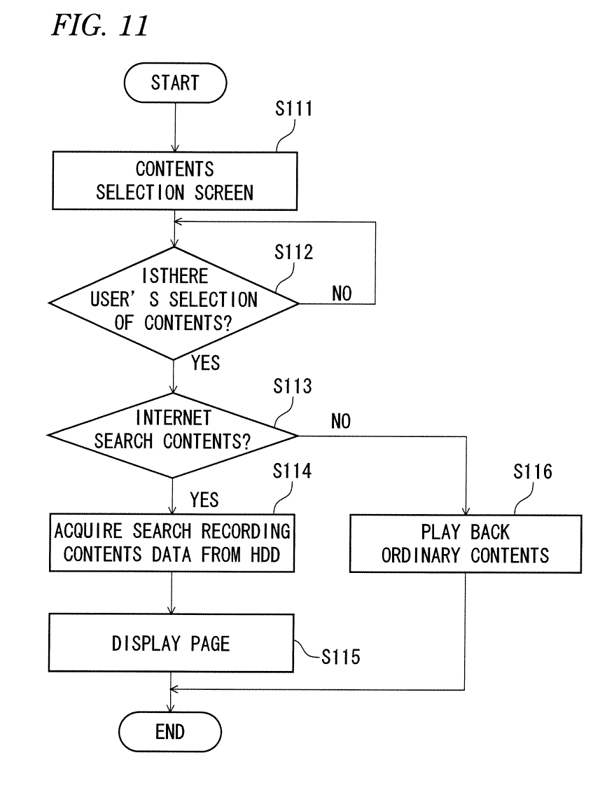

FIG. 11 is a flow chart showing an example of a interne search contents display process in the embodiment.

Upon reception of a user's instruction to display contents, the contents playback module 36 reads moving picture contents and interne search contents from the HDD 170, creates a contents selection screen 71 by using these contents and displays the created contents selection screen 71 (step S111).

Then, the contents playback module 36 waits for user's selection of contents using the contents selection list 72 (step S112). While there is no selection of contents in the step S112 (No in the step S112), the step S112 is repeatedly performed.

When there is a user's selection of contents (Yes in the step S112), the contents playback module 36 determines whether the selected contents are interne search contents or not (step S113).

When the contents selected by the user are interne search contents (Yes in the step S113), data are read from the HDD 170 (step S114) and a Web page is displayed by the browser 32 and the plug-in 33 (step S115). On this occasion, the browser 32 and the plug-in 33 do not need to acquire data (including moving picture data) about the Web page to be displayed from the Internet 4 again because the data are stored as internet search contents in the HDD 170. Moreover, because an image, a configuration file and an execution status are stored as Web page display-related information in the HDD 170, the time required for expanding the Web page can be reduced when these data are used. Accordingly, the browser 32 can display the Web page at high speed.

When the contents selected by the user are not internet search contents in the step S113 (No in the step S113), the contents are moving picture contents so that the contents playback module 36 plays back the moving picture contents (step S 116).

When the step S115 or the step S116 is completed, the series of processes is terminated.

Although the embodiment has been described in the case where the title of a broadcast program is used as a keyword for search on a search site by way of example, the present embodiment is not limited thereto. Another text data about the program such as a category or broadcast contents in the program-related information may be used as a keyword for searching Web pages relevant to the program.

Although the embodiment has been described in the case where internet search contents stored in the HDD 170 are displayed on the DTV 1 by way of example, the present embodiment is not limited thereto. The internet search contents may be outputted to a memory card or another electronic device having a browser. In this manner, the user can browse the internet search contents on another electronic device. When, for example, the internet search contents are outputted to a mobile device which can be carried by the user, the user can browse the internet search contents in a user's preferable condition even in an outdoor environment etc.

In the DTV 1 according to the embodiment, a Web page concerned with a broadcast program selected by a user can be acquired automatically at a preset time.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is Claims is:

1. An electronic device comprising:
a program-related information receiver configured to receive program-related information provided by broadcast waves;
a page data receiver configured to receive data of a Web page at a given time based on text data included in the program-related information; and
a storage configured to store the data of the Web page in a storage medium.

2. The device of claim 1, wherein the page data receiver is configured to search the Web page using the text data on a search Web page, and receive the searched Web page.

3. The device of claim 1, wherein the given time is included in time information of the program-related information.

4. The device of claim 1, further comprising:
an output module configured to output a setting screen for setting the given time, wherein in the setting screen, time information of the program-related information is set as a default value of the given time.

5. The device of claim 1, further comprising:
an image generator configured to generate an image based on the data of the Web page, and
wherein the storage stores the image in the storage medium.

6. The device of claim 5, wherein the storage stores a configuration file for the image and an execution status of the image generator in the storage medium.

7. The device of claim 6, wherein
when the Web page includes moving picture data, the storage stores the moving picture data in the storage medium such that the moving picture data are associated with the image, after the page data receiver receives all the moving picture data.

8. The device of claim 7, further comprising:
a Web page output module configured to output the Web page that is able to be displayed, by using the image, the configuration file, the execution status and part or all of the moving picture data, which are stored in the storage medium.

9. The device of claim 1, further comprising:
a tuner configured to receive the broadcast waves;
an extraction module configured to extract the program-related information from the broadcast waves; and
a display configured to display the Web page based on the data of the Web page, and
wherein the program-related information receiver receives the program-related information from the extraction module.

10. A data receiving method, comprising:
(a) receiving program-related information provided by broadcast waves;
(b) receiving data of a Web page at a given time based on text data included in the program-related information; and
(c) storing the data of the Web page in a storage medium.
